(19) United States
(12) Patent Application Publication
(10) Pub. No.: US 2026/0113629 A1
(43) Pub. Date: Apr. 23, 2026

(54) UTILISE 5G MOBILE HANDSET AS DAO AND NODE IN LAYER 1 PROOF OF AUTHORITY BLOCKCHAIN

(71) Applicant: Frode Van Der LAAK, Gjettum (NO)

(72) Inventor: Frode Van Der LAAK, Gjettum (NO)

(21) Appl. No.: 18/920,900

(22) Filed: Oct. 20, 2024

(51) Int. Cl. H04W 12/06

(52) U.S. Cl. CPC H04W 12/06

(57) ABSTRACT

As the demand for real-time, secure, and scalable transactions continues to grow, the convergence of 5G mobile connectivity and blockchain technology emerges as a promising solution. The present invention depicts an innovative approach to harness the high-speed and low-latency capabilities of 5G mobile networks by integrating them as nodes within a Layer 1 Proof of Authority (PoA) blockchain architecture tailored for microtransactions. This integration yields several advantages. Firstly, the ultra-fast data transmission speeds and minimal network latency of 5G networks enhance the efficiency of blockchain transactions, facilitating near-instantaneous settlement of microtransactions. Secondly, the distributed nature of the blockchain, coupled with the security features inherent in 5G networks, ensures a resilient and tamper-proof transactional environment.

### TECHNICAL FIELD

This disclosure relates to integration of blockchain technology with telecommunications, focusing on the utilization of 5G mobile networks to optimize the scalability, security, and efficiency of blockchain transactions. Specifically, the invention employs a Proof of Authority (PoA) consensus mechanism to enhance the reliability and performance of blockchain networks operating over 5G infrastructure.

### BACKGROUND

In recent years, the surge of interest in blockchain technology has led to its widespread adoption across diverse sectors. A crucial hurdle in blockchain networks revolves around establishing consensus among participants. The Proof of Authority (PoA) consensus algorithm has garnered acclaim for its scalability and energy efficiency. This section delves into the cutting-edge developments in PoA blockchain networks and delves into the integration of 5G mobile connections as nodes in Layer 1 PoA blockchains, particularly for microtransactions.

PoA, or Proof of Authority, stands as a pivotal algorithm within blockchain ecosystems, facilitating swift transactions through a consensus mechanism grounded in identity stakes. In PoA-based networks, approved accounts, known as validators, validate transactions and construct blocks. These validators execute software tasked with organizing transactions into blocks, a process that operates autonomously, eliminating the necessity for constant monitoring.

Proof of Authority (PoA) serves as a consensus algorithm reliant on a designated group of trusted authorities or validators to authenticate transactions and forge new blocks. Unlike Proof of Work (PoW) and Proof of Stake (PoS) algorithms, where participants compete or stake tokens, PoA mandates validators to be identified and sanctioned by the network.

Within PoA, block validators are recognisable entities with documented addresses and public keys, simplifying the detection of malicious actors. Validators typically earn their roles based on their standing, expertise, or stake within the network. Once authorized, a validator contributes to block creation and transaction validation. Consensus materializes when most validators concur on transaction validity and block order.

The PoA consensus algorithm proffers numerous advantages over its counterparts. It obviates the need for resource-intensive mining or staking, leading to diminished energy consumption and heightened scalability. Furthermore, PoA affords swifter block confirmation times, rendering it suitable for applications necessitating high transaction throughput.

Blockchain technology has introduced a transformative era across various industries, offering secure and decentralized transaction capabilities. Within this landscape, microtransactions have emerged as a focal point due to their potential for facilitating swift and cost-effective transactions. However, the widespread adoption and efficient implementation of blockchain microtransaction systems face several challenges.

While the prior solutions may be implemented in a centralized manner, such approaches have significant drawbacks. One of the major problems are scalability. The scalability remains a major concern in blockchain systems, particularly when processing numerous microtransactions. This issue results in prolonged confirmation times and elevated transaction fees, hampering the realization of efficient and real-time blockchain microtransactions. Moreover, establishing trust between users and stakeholders poses a significant challenge. In decentralized setups, reliance on consensus mechanisms is essential to ensure the validity and fairness of transactions. However, these mechanisms are not flawless and can occasionally fail, potentially leading to issues like double spending.

Privacy and security stand as critical considerations in the realm of blockchain microtransactions. While blockchain offers immutability and transparency, safeguarding the privacy and security of microtransactions is imperative. Ensuring user anonymity, protecting sensitive transaction details, and thwarting unauthorized access or tampering present substantial challenges that demand attention.

Interoperability among blockchain networks and platforms is vital for facilitating seamless microtransactions between users and applications. Developing standardized protocols and frameworks that enable cross-blockchain communication can enhance the usability and functionality of blockchain microtransaction systems.

Addressing the energy efficiency of blockchain consensus algorithms, such as proof-of-work, is essential to mitigate concerns regarding environmental impact and energy consumption associated with microtransaction processing. Exploring energy-efficient consensus mechanisms or optimizing existing ones can alleviate these concerns. Enhancing the user experience and fostering widespread adoption of blockchain microtransaction systems necessitates prioritizing an intuitive, user-friendly interface accessible to individuals with diverse technical backgrounds. Understanding user requirements, designing intuitive interfaces, and overcoming usability challenges are crucial steps in this endeavor. For a visual representation of the transactions through blockchain, please refer to FIG. 1, Transactions through Blockchain.

In leveraging blockchain for small transactions, various benefits emerge. With blockchain transactions being irreversible, the absence of intermediaries reduces transaction costs, while the swiftness of blockchain payments ensures prompt receipt of goods or services. However, challenges persist, including the need for trust in transactions and the necessity for further development to bolster adoption.

A consortium blockchain approach enhances the safety and privacy of small transactions for customers. By utilizing a secure system for storing information and transactions, businesses can induce greater trust in online services. Consortium blockchains, managed jointly by multiple organizations, offer enhanced data protection and security compared to traditional centralized databases, making them an ideal choice for businesses seeking to share information while maintaining privacy and control.

In the solution of this, the present invention provides an optimized PoA consensus algorithm tailored specifically for mobile nodes operating within a 5G environment. This algorithm capitalizes on the inherent trustworthiness and integrity of mobile nodes functioning as standalone servers, while carefully considering the unique characteristics of 5G networks. It incorporates robust mechanisms aimed at thwarting collusion, ensuring fairness, and mitigating the risk of malicious activities. Through rigorous performance evaluation and comparative analysis against existing consensus mechanisms, the algorithm demonstrates remarkable efficiency.

The PoA blockchain offers several advantages for facilitating small payments within government frameworks. Notably, its swift transaction processing capabilities are particularly well-suited for micropayments, crucial for expediency in public service transactions. Its scalability and ease of expansion also accommodate the growing user base reliant on public services. Moreover, the PoA blockchain's robust security features, ensuring consensus among all parties involved, are pivotal for safeguarding sensitive government information.

With the burgeoning usage of mobile devices for multimedia consumption and gaming, there is a growing demand for high-speed internet connectivity. The advent of 5G wireless technology represents a significant leap forward in this regard, offering unparalleled speed and data handling capabilities. Its ability to simultaneously process vast amounts of information while minimizing communication latency heralds a new era of advanced connectivity, as depicted in FIG. 2, Mobile Phone Performance. To leverage the full potential of 5G, leveraging a broader spectrum of frequencies, including millimeter-wave frequencies, is imperative. Despite the challenges posed by the limited propagation range of high frequencies, innovative solutions like massive MIMO hold promise in enhancing internet speed and reliability.

However, the deployment of 5G infrastructure presents challenges due to the need for numerous small cells deployed near compensate for the limited coverage of high-frequency signals. The adoption of blockchain technology offers a potential solution to streamline the setup process. By leveraging blockchain as a decentralized database, mobile operators can efficiently manage and coordinate the deployment of 5G infrastructure, ensuring optimal coverage and performance.

Accordingly, what is needed are systems that being capable of facilitating the above-mentioned drawbacks of the prior art solutions.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it is not intended to limit the scope of the invention to these particular embodiments.

FIG. 1 depicts transaction through block chain according to embodiments of the present invention.

FIG. 2 depicts mobile phone performance according to embodiments of the present invention.

FIG. 3 depicts mobile phone performance during the PoA according to embodiment of the present invention.

FIG. 4 depicts execution of PoA according to embodiments of the present invention.

FIG. 5 depicts designing a Layer 1 PoA Blockchain according to embodiment of the present invention.

FIG. 6 depicts an architecture of the proof of authority base node according to embodiments of the present invention.

FIG. 7 depicts the communication channel between light node and user handset in the cluster according to embodiments of the present invention.

FIG. 8 depicts the status of the node according to embodiments of the present invention.

### DETAILED DESCRIPTION OF THE PREFERRED EMBODIMENT

In the following description, for purposes of explanation, specific details are set forth to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a 5G devices.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional, or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

Furthermore, it shall be noted that: (1) certain steps may optionally be performed; (2) steps may not be limited to the specific order set forth herein; (3) certain steps may be performed in different orders; and (4) certain steps may be done concurrently.

An aspect of some embodiments of the present invention is to provide increased decentralization by leveraging mobile devices as validation nodes which contributes significantly to bolstering decentralization within the network. With mobile devices being widespread and utilized across diverse demographics, they expand the pool of potential validation nodes, thereby enriching the network's decentralization. This distributed ownership model fosters inclusivity and resilience, curbing the risk of centralization and encouraging democratic participation in network governance.

An aspect of some embodiments of the present invention is to provide lower entry barrier so that more user can be able to participate. In contrast to Proof of Work (PoW) systems, which necessitate substantial computational resources, PoA systems on mobile handsets substantially reduce the entry barrier for participation. Mobile handsets, being ubiquitous and easily accessible, enable a broader and more diverse user base to engage with the blockchain network without the need for expensive or specialised hardware. This democratisation of access promotes inclusivity and participation, cultivating a diverse and dynamic ecosystem.

An aspect of the present invention is to provide an energy-efficient solution for current PoW network usage. PoA networks deployed on mobile devices exhibit noteworthy energy efficiency compared to traditional mining setups. Mobile handsets inherently consume significantly less power, rendering PoA networks environmentally sustainable. By harnessing mobile devices as validation nodes, energy consumption is minimised, aligning with global sustainability initiatives and reducing the carbon footprint associated with blockchain operations.

An aspect of the present invention is to provide enhanced security by introducing the PoA systems which capitalise on pre-selected and trusted validators, further bolstered by the robust security features inherent in modern mobile handsets.

An aspect of the present invention is to provide real time validation. The perpetual connectivity and operational status of mobile devices enable real-time transaction validation within PoA networks. Mobile handsets remain consistently online and interconnected, eliminating the need for dedicated infrastructure for validation processes. This real-time validation capability enhances network efficiency and responsiveness, facilitating seamless transaction processing and enabling swift decision-making.

An additional aspect of the present invention is to employing mobile handsets as nodes presents a cost-effective approach to network infrastructure maintenance. Users can seamlessly integrate their existing mobile devices into the blockchain network without additional investment in specialized hardware. This cost-effective model reduces financial barriers to participation, fostering widespread adoption and sustainability within the network ecosystem.

An aspect of the present invention is to provide geographical distribution of nodes within the network. With mobile devices ubiquitous across diverse regions and demographics, the network nodes can be dispersed geographically. This geographical diversity enhances network resilience and robustness, mitigating the impact of localized disruptions and strengthening the network against potential centralized control or censorship efforts.

A broad aspect of the present invention provide utilization of 5G Mobile Handset as DAO and Node in Layer 1 Proof of Authority Blockchain to enabling near-instantaneous settlement of microtransactions.

As per one of the problem solutions in which the blockchain can stop people from spending the same money twice because of the person or group being capable of verifying and approving every transactions. This approach employs a centralized authority to oversee transactions, ensuring the integrity of each transaction by preventing double spending. This centralized authority maintains a comprehensive ledger of all transactions and verifies new transactions against this ledger. If any attempt at double spending is detected, the transaction is rejected.

5G technology presents an opportunity to enhance this system's efficiency and scalability. By utilizing 5G mobile connections as nodes in a Layer 1 Proof of Authority (PoA) blockchain, specifically tailored for microtransactions, we can capitalize on the speed, low latency, and high bandwidth capabilities of 5G networks while benefiting from the security and reliability of PoA consensus.

To construct a Layer 1 PoA blockchain optimized for microtransactions, certain key components must be addressed:

Consensus Mechanism: The implementation of a Proof of Authority consensus algorithm relies on trusted nodes, established using 5G mobile connections. This ensures rapid and dependable communication among participants in the blockchain network, facilitating swift transaction validation.

Scalability: Leveraging the ample bandwidth provided by 5G connections enables a significant increase in the number of transactions processed per second (TPS) compared to traditional blockchain networks. This scalability is essential for accommodating the high-volume nature of microtransactions, ensuring the system can handle substantial transaction loads effectively.

The technology's transformative capacity adeptly addresses the high-volume demands inherent in microtransactions, allowing the system to efficiently handle significant loads without compromising performance. A comprehensive depiction of mobile phone performance during this robust operation is illustrated in FIG. 3: Mobile Phone Performance during PoA. Security and trust are paramount, ensured by PoA consensus relying on trusted nodes, with mobile operators and reputable organizations serving as validators to uphold network integrity and deter malicious activities. The network architecture is meticulously designed to optimize the distributed nature of 5G mobile connections, prioritizing low-latency communication to facilitate swift transaction confirmation and deliver a seamless user experience for microtransaction participants. Integration of the Layer 1 PoA blockchain with the existing 5G infrastructure is seamlessly executed within this framework.

Security and Trust: PoA consensus guarantees a high level of security by entrusting transaction validation to reputable nodes. Mobile operators and established organizations can serve as validators, safeguarding the network from malicious activities and ensuring its integrity.

Network Architecture: Designing an optimized network architecture that capitalizes on the distributed nature of 5G mobile connections. This architecture prioritizes low-latency communication, facilitating rapid transaction confirmation and delivering a seamless user experience for microtransaction participants. Integration of the Layer 1 PoA blockchain with existing 5G infrastructure is essential for seamless operation and widespread adoption.

In embodiments, incorporating 5G mobile networks as nodes within a Layer 1 Proof of Authority (PoA) blockchain structure for microtransactions represents a pioneering solution to tackle critical challenges across diverse business sectors. One of the key rationales behind this integration is the imperative for accelerated transaction speeds and minimized latency. The advent of 5G networks, distinguished by their exceptional data transfer speeds and minimal latency, presents an opportune moment to surmount this bottleneck. For instance, consider the financial sector, where swift and secure microtransactions are paramount. Traditional banking systems often struggle to swiftly process a large volume of microtransactions, leading to delays and increased operational expenses. By integrating 5G networks into the blockchain, financial institutions can notably expedite microtransaction processing, thereby lowering costs and bolstering overall efficiency. Furthermore, the integration of 5G into the blockchain architecture harbours immense potential for the Internet of Things (IoT) landscape. IoT devices, increasingly ubiquitous across various industries, necessitate seamless and instantaneous communication for tasks such as sensor data reporting, automated decision-making, and remote control. By leveraging 5G's low latency and high-speed capabilities within a blockchain framework, IoT devices can interact in real-time, unlocking a plethora of new applications and possibilities.

In embodiment, an integration of 5G mobile devices into data networks brings about nearly instantaneous responses, due to the low latency inherent in 5G technology. This attribute proves invaluable for applications demanding real-time interactions like online gaming, telemedicine, and autonomous vehicles. Moreover, 5G mobile networks may offer unparalleled mobility compared to server-based solutions, allowing users to access the network from virtually anywhere without being tethered to physical servers. With built-in edge computing capabilities, 5G networks may enable data processing and analysis closer to the data source, decentralizing computing resources and facilitating quicker decision-making. This feature is particularly beneficial for applications reliant on real-time data analytics, such as smart cities and industrial automation. Furthermore, while managing servers connected to 5G networks can incur significant hardware and operational costs, 5G mobile devices are readily available in the market, with users typically bearing the cost of their devices and data plans. This cost-sharing model promotes financial sustainability for both individuals and businesses. Additionally, 5G mobile networks offer scalability and flexibility that are challenging to achieve with server-based solutions.

In embodiments, block chain network may be a Proof of Authority (PoA), which works very quickly and can process many transactions at once. This is about small and fast payments called micropayments. The PoA blockchain being capable of handling large number of users and is easy to expand. Further, the PoA blockchain is very safe and has a vital way of ensuring everyone agrees on what is happening.

In embodiments, a novel consensus mechanism for 5G networks, leveraging a mobile-centric Proof of Authority (PoA) approach. By harnessing the inherent trustworthiness of mobile devices as individual servers, the algorithm caters specifically to the characteristics of 5G environments. To ensure robust security, the design incorporates mechanisms that prevent collusion between nodes, promote fairness in participation, and minimize the risks posed by malicious actors. The efficiency of this mobile-centric PoA system is validated through performance evaluations that compare it against existing consensus mechanisms. This approach highlights the potential for significant improvements in efficiency within the 5G network.

In embodiments, invention encompasses a sophisticated system tailored for the deployment of a Layer 1 Proof of Authority blockchain, strategically capitalizing on the functionalities inherent in 5G mobile handsets as pivotal nodes. Central to this system is the establishment of a network comprising 5G mobile handsets, each serving as a node within the blockchain infrastructure. These handsets are equipped with robust identity verification mechanisms, essential for safeguarding the authenticity and integrity of transactions traversing the network. Complementing this network is a meticulously configured Distributed Ledger Technology (DLT) platform, specifically engineered to operate within the dynamic confines of a 5G network environment. This platform is architected to facilitate high transaction throughput, thereby facilitating the expeditious and seamless processing of microtransactions. Leveraging the intrinsic advantages of 5G technology, notably reduced latency, the platform augments the responsiveness and operational efficiency of the blockchain system. Through the integration of these components, the invention establishes a robust framework poised to harness the transformative potential of 5G technology within the blockchain landscape, while simultaneously ushering in a new era of secure and efficient microtransaction processing.

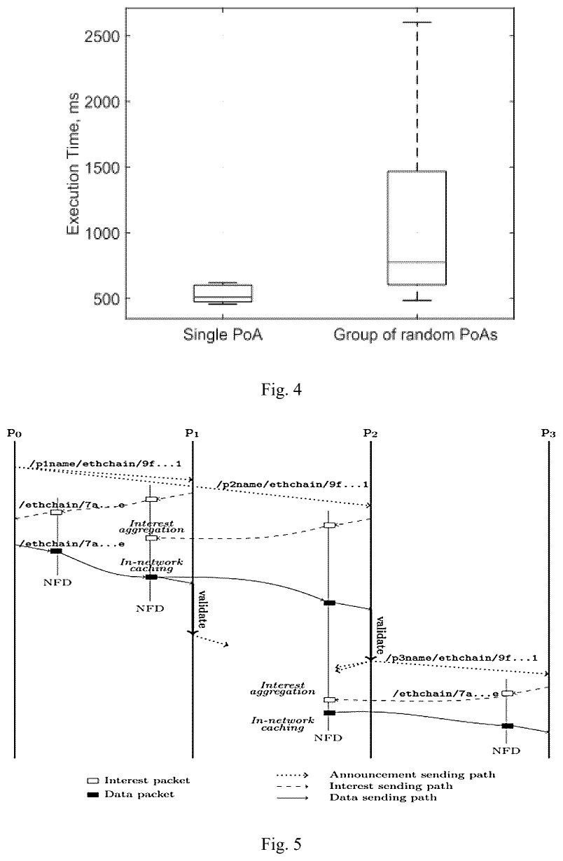

Referring to FIG. 4, it depicts the execution of the PoA consensus algorithm in blockchain network. Proof of Authority is a method for validating transactions and creating new blocks in a blockchain.

In embodiments, Proof of Authority (PoA) system having, validators, recognized as trusted nodes, play a pivotal role in proposing and validating blocks. The reputation of these validators serves as a cornerstone in securing the system. Any malicious behaviour by a validator can be swiftly identified, leading to their removal from the network and tarnishing their reputation.

In embodiments, the “Execution of PoA” denotes the operational process wherein these authority nodes fulfil their duties within the blockchain network. This encompasses validating transactions, proposing new blocks, and upholding the integrity of the blockchain. This mechanism holds particular significance in private and permissioned blockchain networks, where participants are identifiable and trusted entities.

In embodiments throughout the invention, Micropayments are enabling seamless, secure, and low-cost micropayments between IoT devices, allowing for new business models and increased automation in various industries. In-App Purchases and Digital Content facilitates frictionless microtransactions within mobile applications, allowing users to make small purchases or access digital content with ease and security. Mobile Payments and Digital Wallets provides a fast and reliable platform for mobile payment services, enabling users to make instant micropayments using their smartphones while ensuring the security of their transactions.

Referring to FIG. 5, it depicts designing of a Layer 1 Proof of Authority (PoA). It involves creating the foundational layer of a blockchain system that uses the PoA consensus algorithm. Layer 1 in blockchain architecture refers to the base protocol level, including transaction validation and block creation.

In a PoA consensus model, the system relies on a limited number of trusted nodes, known as validators, to propose and validate new blocks. As such, the reputation of these validators is crucial to maintaining the integrity and security of the network.

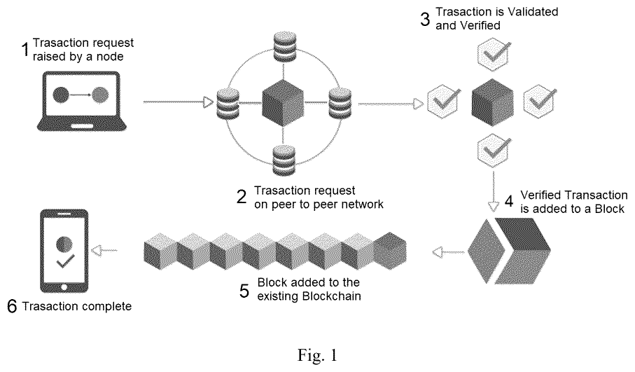

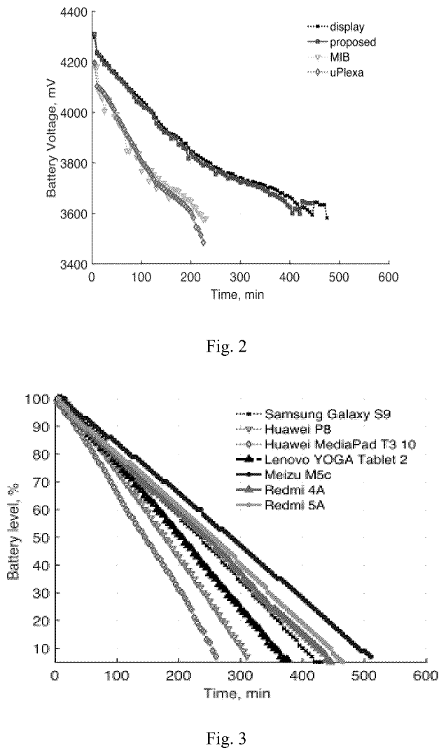

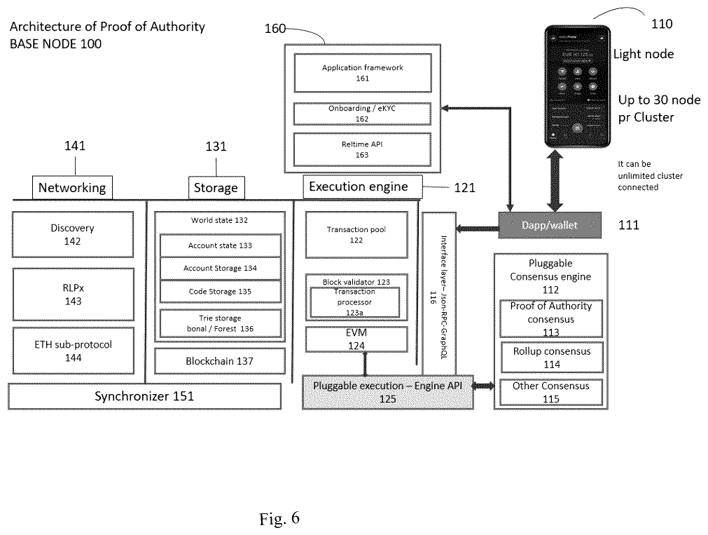

Referring to FIG. 6, one cluster may have up to 30 light nodes. The clusters can be one or more and being communicatively coupled to each other. Each light node may have been installed with the block chain and more particularly block chain having Proof of Authority (PoA) system. The FIG. 1 depicts workings of a Proof of Authority (PoA) system, providing a comprehensive breakdown of its architectural components. The system leverages a decentralized architecture facilitated by interconnected nodes, each playing a specific role in maintaining the integrity and security of the blockchain network.

In embodiments, light node 110 is a type of node that downloads only a subset of the blockchain data. Light nodes are faster and more efficient to run than full nodes.

In embodiments, block Dapp/Wallet 111 refers to decentralized applications (DApps) and cryptocurrency wallets that interact with the PoA system. The Dapp/Wallet 111 may store in the light node 110. The block Dapp/Wallet 111 may communicatively couple to the interface layer 116 and pluggable execution engine API 125. Also, Dapp/Wallet 111 communicatively coupled to the block 160.

In embodiments, pluggable consensus engine 112 may comprising proof of authority consensus 113, Rollup consensus 114, and another consensus 115. The pluggable consensus engine 112 may communicatively couple to said pluggable execution-engine API 125. The Pluggable Consensus Engine API 125 refers to an API that allows developers to plug in their own consensus engines into the system. The Interface layer 116 refers to the interface layer that allows applications to interact with the PoA system using JSON-RPC and GraphQL APIs.

In embodiment, execution engine 121 may have transaction pool 122, block validator 123, and EVM 124. The block validator 123 may having transaction processor 123a. The EVM 124 Stands for Ethereum Virtual Machine. It's a runtime environment for smart contracts. Smart contracts are self-executing contracts stored on a blockchain that can be invoked to automate the execution of specific tasks. The block validator 123 refers to the component that validates new blocks before they are added to the blockchain. The transaction processor 123a refers to the component that processes transactions on the blockchain network.

In an embodiment, storage 131 may having world state 132. The block 132, may having account state 133, account storage 134, and code storage 135, along with the trie storage bonal/forest 136. The world state 132 refers to the current state of all accounts and smart contracts on the blockchain network. The account state 133 stores information about individual accounts on the blockchain network. The account storage 134 refers to the storage specifically designated for blockchain accounts. The trie storage 136 refers to a Patricia tree, a type of Merkle tree used in the Ethereum blockchain to store data efficiently.

In embodiments, the blockchain 137 facilitates bidirectional communication between devices, allowing them to exchange messages seamlessly. For instance, a message can be transmitted to or received from a device using the blockchain.

In embodiments, networking 141 may comprising blocks as discovery 142, RLPx 143, and ETH sub-protocol 144. The discovery 142 block refers to the process of finding other nodes on the network to communicate with. The RLPx 143 stands for Recursive Length Prefix. It's a peer-to-peer (P2P) messaging protocol used in the Ethereum blockchain.

In embodiments, the synchronizer 151 block refers to a component that keeps a node's copy of the blockchain synchronized with the rest of the network.

In embodiments, Onboarding/eKYC 162 block refers to the process of onboarding new users and performing Know Your Customer (KYC) checks. KYC is the process of verifying a user's identity to prevent money laundering and terrorist financing. The reltime API 163 block refers to an API that provides real-time access to data on the blockchain network.

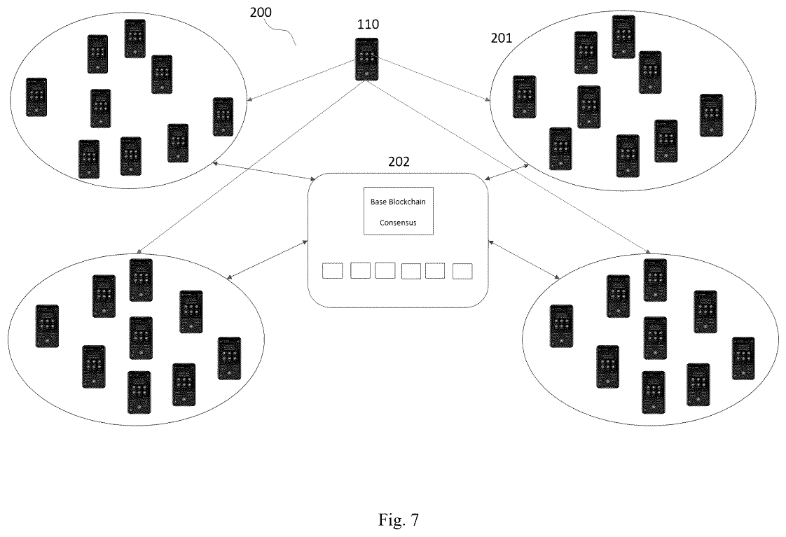

Referring to FIG. 7, it depicts an embodiment of the distributed peer-topeer network 200, which comprises a plurality of clusters 201. Each cluster 201 containing the individual light node 110. The number of light node 110 in a single cluster 201 cannot be exceeding to the 30 light nodes 110. Upon registering as a new user, the user can select the cluster 201 in which the user wants to join. The condition must be that the user must be authenticate and the cluster 201 can have less than 30 light node 110 in the cluster. Upon using mobile handset as a node, user need to synchronize all the light node 110, and so the user than become node validator having details of the all previous transactions sync with their mobile handset.

In embodiment, said cluster 201 being communicatively coupled to the blockchain consensus, so upon adding the block in the blockchain 202, all the light node 110 being notified. The user can put into the waiting list if the cluster 201 being full with the light nodes 110. The user may try to join the popular cluster 201 first which having more transactions. If the transaction numbers in the cluster 201 are high, the node validator can earn more on transactions.

In embodiment, In a blockchain network, particularly in a Proof of Authority (PoA) model, the synchronization process for a new node (such as a mobile handset) involves several key steps to ensure the node has the complete and up-to-date copy of the blockchain before it can begin validating transactions. Here's a step-by-step breakdown of how a node, like a mobile handset, would synchronize in a PoA network:

### 1. Initial Setup and Configuration

Install Blockchain Software: The first step is installing the necessary blockchain client software on the mobile device. This software must be compatible with the PoA network's specific protocol and rules.
Configure the Node: Set up the node with the required configurations, including connecting it to the appropriate network and specifying it as a validator node if it is to participate in the validation process. In PoA, authority to validate might need specific permissions or identity verification.

### 2. Connecting to Peers

Discovery of Peers: The node uses a discovery protocol to find other active nodes in the network. This could be facilitated through a list of trusted nodes (often the case in PoA networks) or through a more dynamic peer discovery mechanism.
Establish Connections: Once peers are discovered, the node establishes connections to several other nodes to start the data exchange process.

### 3. Downloading the Blockchain

Download Blocks: The new node begins downloading blocks from its peers, from the first (genesis block) to the most current block. In some implementations, nodes can download blocks in parallel from multiple peers to speed up the process.
Verify Blocks: As blocks are received, the node verifies each block against the blockchain's rules and its integrity (e.g., checking signatures of the validators who confirmed each block, as required in PoA).

### 4. State Synchronization

Download Current State: For networks where the current state is necessary (such as account balances, smart contracts state, etc.), the node may download the current state directly or reconstruct it by executing all transactions from the genesis block.
State Verification: The integrity and correctness of the state are verified to ensure that the node accurately represents the blockchain's current state.

### 5. Catch Up to the Network

Process New Transactions: As the node catches up to the latest block, it starts participating in the network by receiving new transactions.
Participate in Consensus: Once fully synchronized, the node can begin validating new blocks if it is authorized to do so in a PoA network. This involves participating in the consensus process, proposing new blocks (if the node is a designated proposer), and verifying blocks proposed by other validators.

### 6. Continuous Synchronization

Stay Updated: The node must continuously receive and verify new blocks and transactions to remain synchronized with the network.

### Considerations for Mobile Handsets

Resource Constraints: Mobile devices are generally less powerful and have less storage capacity compared to traditional nodes run on servers. Efficient use of resources and possibly relying on light client protocols might be necessary.
Connectivity Issues: Mobile nodes must handle connectivity issues gracefully, ensuring that they can quickly resynchronize after losing and regaining network connection.

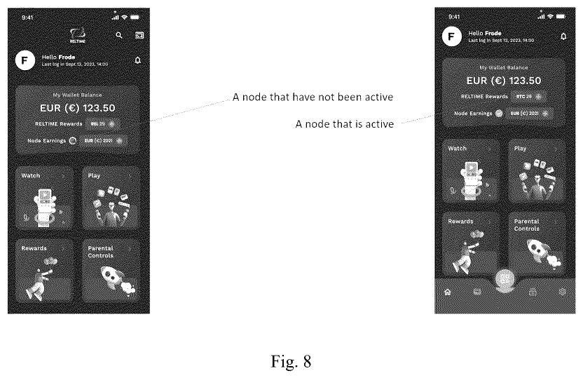

In the embodiment, the user needs to install the application and register themselves as node validators. Upon validating the user registration, the green light will reflect in the application, which shows that the node is active. If the node validator is not active, the red light will reflect in the application. FIG. 8 depicts the status of the node, whether it is an active node or not active node 110.

In an embodiment, to simulate the synchronization time for a node within a Proof of Authority (PoA) network under the provided conditions, we need to account for specific details:
1. Network Bandwidth: Utilizing a 5G mobile network with moderate speed, assumed to have a typical download speed of approximately 100 Mbps.
2. Blockchain Size: The blockchain size is around 400 GB, but can be less as an cluster node is can be created instant when new node validator activate them self as node validator, a substantial amount that prompts consideration for synchronisation method—whether via mobile network or alternative means like WIFI.
3. Block Processing Speed: Transactions are processed at a rate of 37,000 transactions per second (TPS), with each block taking 2 seconds to form, and weighing in at 9,600 bytes.
4. State Size: Assuming the state synchronization to be expedited, requiring minimal time beyond download and processing.
5. An optimise Cluster include around 30 Identity based users to operate the consensus in the cluster, when a cluster is full with node validator it automatic create a new cluster with calculating around 30 node, in this case the node validator drop out from a cluster, it can approve new validators.

Calculating the synchronization times involves several steps:

### Download Time Calculation

Blockchain Size: 400 GB.
Download Speed: 100 Mbps (Megabits per second), equivalent to 12.5 MBps (Megabytes per second).

### Block Processing Time Calculation

Derive the total number of blocks.
Calculate the download time in seconds (size in bytes divided by download speed in bytes per second).
Determine the block processing time assuming minimal processing delay for state synchronization.

Based on these parameters, here's the breakdown:

Download Time: It takes approximately 34,360 seconds, or about 9.5 hours, to download the entire 400 GB blockchain at a download speed of 100 Mbps.
Number of Blocks: Roughly 44,739,243 blocks constitute the blockchain, calculated by dividing the total blockchain size by the size of each block (9,600 bytes).
Total Synchronization Time: The primary synchronization time stands at about 9.5 hours, considering download as the predominant time component. This estimate excludes the minimal state synchronization time, assumed to be rapid in this scenario.

These calculations presuppose efficient data handling by the node, without bottlenecks such as storage write speed or processing limitations. The “minimal state synchronization time” assumption signifies that once blockchain data is downloaded, the node swiftly verifies and updates its status, likely facilitated by optimized algorithms or client software.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all the various components of a module, whether control logic or other components, may be combined in a single package or separately maintained and can further be distributed in multiple groupings or packages or across multiple locations.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved, or may be executed in a different order. Other steps and methods may be conceived that are equivalent in function, logic, or effect to one or more blocks, or portions thereof, of the illustrated Figures.

1. A method for enabling blockchain transactions harnessing the capabilities of a 5G mobile handset within a Layer 1 Proof of Authority (PoA) blockchain, comprising:
Authentication of the mobile handset owner's identity, establishing them as a trusted validator within the PoA blockchain;
Leveraging the high-speed, low-latency 5G connection for seamless real-time data transmission and reception essential for blockchain transactions;
Direct processing and validation of microtransactions within the blockchain network directly from the 5G mobile handset.

2. The method as claimed in claim 1, wherein using a 5G mobile handset significantly augments transaction speeds owing to its high-bandwidth and low-latency 5G connection, thereby enabling near-instantaneous settlements of microtransactions.

3. The method as claimed in claim 1, wherein for synchronizing a new node, such as a mobile handset, within a Proof of Authority (PoA) blockchain network, comprising the steps of:
installing blockchain client software compatible with the PoA network's protocol and configuring the node, including connection setup and validator node specification if required;
using a discovery protocol to locate active nodes in the network and establishing connections for data exchange;
initiating the download of blocks from peers, beginning from the genesis block to the most current one, and verifying block integrity against blockchain rules;
obtaining the current state directly or reconstructing it by executing transactions from the genesis block, followed by state verification to ensure accurate representation of the blockchain's current state;
processing new transactions as the node catches up to the latest block, and participating in consensus processes if authorized, including proposing and verifying blocks;
ensuring continuous receipt and verification of new blocks and transactions to maintain synchronization with the network.

4. The method as claimed in claim 1, wherein said new user being capable of selecting of the cluster in which the user wants to participate.

5. The method as claimed in claim 1, wherein said new user is capable of entering only if the cluster has space to add a new node; said cluster is capable of accommodating 30 light nodes.

6. A system for implementing a Layer 1 Proof of Authority blockchain, employing 5G mobile handsets as integral nodes, comprising:
a network composed of 5G mobile handsets serving as nodes, each handset integrating a secure identity verification mechanism essential for validating transactions.
deployment of a distributed ledger technology (DLT) platform meticulously configured to function within a 5G network environment, adept at supporting high transaction throughput and minimized latency, particularly conducive for microtransactions.

7. The system according to claim 3, additionally incorporating a smart contract execution environment, facilitating automated and self-executing transactions within the PoA blockchain;
said transactions being validated by the extensive network of 5G mobile handset nodes, ensuring efficiency and reliability in transaction processing.

8. The system as claimed in claim 6, a blockchain system, comprising:
an execution engine configured to execute code associated with decentralized applications (DApps) and smart contracts;
a storage system configured to store the current state of all accounts and smart contracts, information about individual accounts, and blockchain data;
a networking module configured to facilitate communication between nodes on the network;
a consensus engine configured to validate transactions and maintain consensus on the state of the blockchain; and
an interface layer configured to enable interaction with the blockchain system using application programming interfaces (APIs).

9. The system according to claim 6, said new node validator can be automatically connected to a cluster when they activate themselves; the users can choose the cluster to be connected to.
